(19) United States
(12) Patent Application Publication
(10) Pub. No.: US 2006/0169960 A1
(43) Pub. Date: Aug. 3, 2006

(54) Safety buffer for guide rails

(76) Inventor: Shaohan Li, Guangdong Province (CN)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/100,809

(22) Filed: Apr. 6, 2005

(30) Foreign Application Priority Data
Apr. 6, 2004 (CN) CN 200420044546.9
Feb. 8, 2005 (CN) CN 200510052368.3

(51) Int. Cl. B66D 1/14

(52) U.S. Cl. 254/341; 254/343

(57) ABSTRACT

A safety buffer for guide rails is a buffer device mounted on the guide rails, which comprises a rack and a unilateral damping device. Wherein the unilateral damping device comprises a bottom shell, a middle shell, a top shell, a damping case with convex shaft, a damping case cover, a damping sheet with middle shaft, a seal ring and a gear. A slot with long axis and short axis is positioned respectively on the bottom shell and the top shell, the damping sheet is mounted in the damping case, the middle shaft of the damping sheet goes through the damping case and the extruded portion is fixedly connected with the gear, the end of the middle shaft of the damping sheet goes into the slot of the upper face of the top shell; the damping case has a tooth on its outer circumference, the convex shaft of the damping case goes into the slot of the lower face of the external housing; a brake tooth locates on one side of the inner wall of external housing along the long axis of the slot; the gear engages with the rack. The safety buffer for guide rails according to the present invention shall not hurt people's hands when using it under any conditions. It has a strong safety and practicability without noise, and adapts to any drawers needed to close tightly and the open and close orbit of the congeneric machine.

### CROSS-REFERENCE TO RELATED APPLICATIONS

The present patent application claims priority from Chinese Patent Application No. 200420044546.9 filed on Apr. 6, 2004, and Chinese Patent Application No. 200510052368.3 filed on Feb. 8, 2005.

### FIELD OF THE INVENTION

The present invention relates to a drawer guide rails accessory, particularly to a buffer device mounted on the guide rails of the drawer.

### BACKGROUND OF THE INVENTION

In the prior art, in order to close drawer tightly, the end portion of the drawer guide rail is designed to be a declivity, or a set of spring resilient device is disposed at the end portion of the guide rail; when pulling out the drawer, the spring stores energy, and it restores when the drawer is pushed into the end. Both said methods can generate an inside-pressing force on the drawer when the drawer slides into the end, such that the drawer to be closed tightly. However, this results in new problems that it will generate biggish noise when the drawer moves towards inside at an accelerated speed as it is near to the closing position, and if the user carelessly touches the flange of the drawer, his/her finger will possibly be pinched by the drawer; when putting unnatural huge strength on the drawer to close it, it may hurt the finger, and generate a big noise.

### DESCRIPTION OF THE INVENTION

Since the prior drawer guide rails have a certain security threats and the disadvantage of big noise, the object of the present invention is to provide a safety buffer for guide rails which will enable the drawer to move slowly to joint at the last state when pushing forwards.

The safety buffer for guide rails according to the present invention comprises a rack and a unilateral damping device, wherein the unilateral damping device comprises a bottom shell, a middle shell, a top shell, a damping case with convex shaft, a damping case cover, a damping sheet with middle shaft, a seal ring and a gear. A slot with long axis and short axis is positioned respectively on the bottom shell and top shell, and the long axis of the slot shares the same direction with the movement of the drawer; a through hole is arranged on the damping sheet which is mounted in the damping case, the damping case is filled with damping oil, the damping case cover covers the damping case, the middle shaft of the damping sheet goes through the damping case and the extruded portion is fixedly connected with the inner hole of the gear, the end of the middle shaft of the damping sheet goes into the slot of the top shell; the damping case has a tooth on its outer circumference, the convex shaft of the damping case is coaxial with the middle shaft of the damping sheet and goes into the slot of the bottom shell; a brake tooth locates on one side of the inner wall of the middle shell along the long axis of the slot; the gear engages with the rack. In the present invention, the length of the rack occupies a subsection of the length of the guide rails, thus the rack will contact with the gear and engage with it at the last stroke when the drawer joints. When pull out the drawer, the rack triggers the gear to enable the middle shaft of the damping sheet and the convex shaft of the damping case to move outwards along the slot till touch the outer side of the slot, in this process, the tooth on the outer circumference of the damping case separates with the brake tooth, no limit on the movement of the damping case, the rack drives the gear to make the damping case race, that the drawer moves outwards is basically not restricted. After the rack disengaged from the gear, the drawer is in a complete free state. And the case is opposite when push forwards the drawer: on the first state, the drawer is in a free state and its movement is not restricted, after the rack engages with the gear, the rack triggers the gear to enable the middle shaft of the damping sheet and the convex shaft of the damping case to move towards the inner side of the slot till the tooth on the outer circumference of the damping case engages with the brake tooth, and the tooth on the outer circumference of the damping case is stuck by the brake tooth, then the damping case will not rotate, at the same time, the rack drives the gear and damping sheet to rotate, at this moment the movement of drawer is restricted, the drawer finishes the last stroke slowly.

The present invention shall not hurt people's hands by using it under any conditions. It has a strong safety and practicability without noise, and adapts to any drawers needed to close tightly and the open and close orbit of the congeneric machine.

### BRIEF DESCRIPTION OF THE DRAWINGS

The present invention will be further described below taken in conjunction with the accompanying drawings, in which:

FIG. 1 is a schematic structure view of the embodiment of the present invention;

FIG. 2 is an exploded view of the embodiment;

FIG. 3 is a state view when the unilateral damping device of the embodiment evacuates;

FIG. 4 is a state view when the unilateral damping device of the embodiment ploughs into it.

### DETAILED DESCRIPTION OF THE EMBODIMENTS

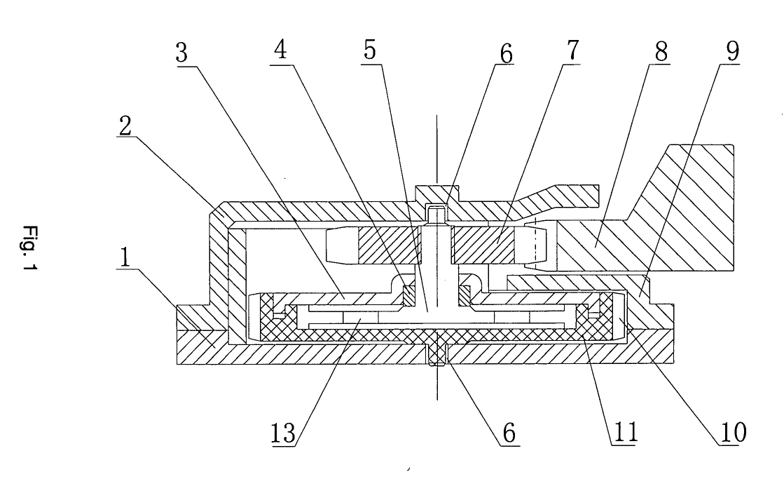

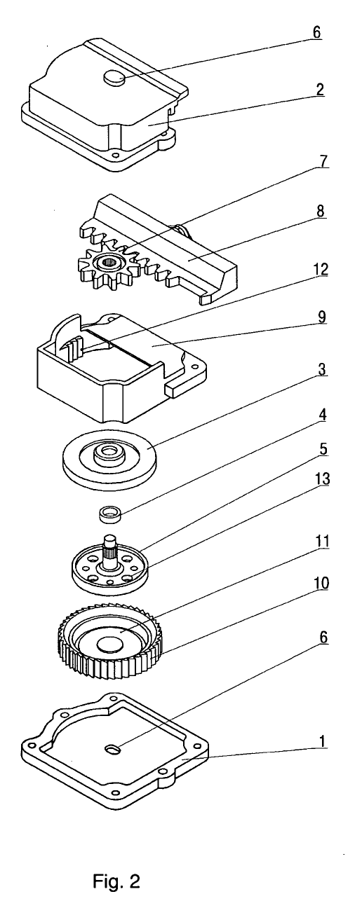

Referring to FIG. 1 and FIG. 2, a rack 8 is arranged on the movable rails which are fixed at the bottom of the drawer; a bottom shell 1, a middle shell 9 and a top shell 2 together constitute the external housing of the unilateral buffer, and the external housing is arranged on the immovable rails which are fixed in the cabinet, a slot 6 with long axis and short axis is positioned respectively on the bottom shell 1 and the top shell 2, and the long axis of the slot 6 shares the same direction with the movement of the drawer; the damping sheet 5 is mounted in the damping case 11, the damping sheet 5 has eight through holes 13, the damping case 11 is filled with damping oil, when the damping sheet 5 rotates in the damping case 11, the damping oil will be extruded through the through holes 13 so as to generate resistance; in order to prevent the damping oil from leaking, a seal ring 4 is arranged on the portion that the middle shaft of the damping sheet 5 goes through the damping case cover 3; the middle shaft of said damping sheet 5 goes through the damping case cover 3 and the extruded portion is connected with the inside hole of the gear 7 by spline, so that the middle shaft of the damping sheet 5 can fixedly connects with the gear 7 while it is easy to arrange the same, the end of the middle shaft of the damping sheet 5 is arranged in the slot 6 of the top shell 2; the damping case 11 has a tooth 10 on its outer circumference, and the tooth 10 is a unilateral ratchet; a convex shaft is arranged on the center of the bottom of the damping case 11, the convex shaft of the damping case 11 is coaxial with the middle shaft of the damping sheet 5, the convex shaft of the damping case 11 is positioned in the slot 6 of the bottom shell 1; a brake tooth 12 forms on the rear side of the inner wall of the middle portion of the middle shell 9, and the tooth 12 is also a unilateral ratchet. In addition, the rack 8 has a single tooth on one side of the drawer along the direction of pulling out the drawer, and the single tooth is designed to be non-continuous and at a certain interval with other tooth; by adjusting correctly the arrangement position of the unilateral buffer on the stable orbit, the gear 7 will not engage with the rack 8 when the drawer is fully jointed, hence, the drawer will be better jointed on condition that it is at a free state when near to joint; the object of arranging a single tooth is to ensure the movable orbit will not surge from the well-assembly stable orbit before the drawer is fixed.

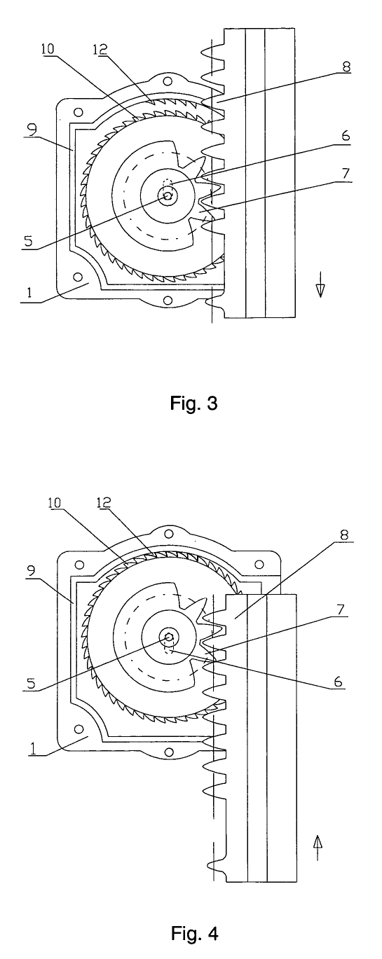

FIG. 3 and FIG. 4 illustrate whether the engagement of the tooth 10 and the brake tooth 12 depends on the direction of movement of the rack 8, namely that of the drawer, accordingly, the present invention is a unilateral damping device which only damps at the last stroke of the drawer.

What is claimed is:

1. A safety buffer for guide rails comprising a rack (8) and a unilateral damping device, characterized in that, the unilateral damping device comprises a bottom shell (1); a middle shell (9); a top shell (2); a damping case (11) with convex shaft; a damping case cover (3); a damping sheet with middle shaft (5); a seal ring (4) and a gear (7); a slot (6) with long axis and short axis is positioned respectively on the bottom shell (1) and the top shell (2), and the long axis of the slot (6) shares the same direction with the movement of the drawer; the damping sheet (5) is mounted in the damping case (11) and rotated therein, the damping case (11) is filled with damping oil, the damping case cover (3) covers the damping case (11), the middle shaft of the damping sheet (5) goes through the damping case cover (3) and the extruded portion is fixedly connected with the inside hole of gear (7), the end of the middle shaft of the damping sheet (5) goes into the slot (6) of the top shell (2); the damping case (11) has a tooth (10) on its outer circumference, the convex shaft of the damping case (11) is coaxial with the middle shaft of the damping sheet (5) and goes into the slot (6) of the bottom shell (1); a brake tooth (12) locates on one side of the inner wall of the middle shell (9) along the long axis of the slot (6); the gear (7) engages with the rack (8).

2. According to the safety buffer for guide rails in claim 1, characterized in that, the middle shaft of said damping sheet (5) goes through the damping case cover (3) and the extruded portion is fixedly connected with the inside hole of the gear (7) by spline.

3. According to the safety buffer for guide rails in claim 1, characterized in that, said seal ring (4) is mounted on the position where the middle shaft of the damping sheet (5) goes through the damping case cover (3).

4. According to the safety buffer for guide rails in claim 1, characterized in that, a through hole (13) is arranged on said damping sheet (5).

5. According to the safety buffer for guide rails in claim 1, characterized in that, said tooth (10) and said brake tooth (12) are unilateral ratchets.

6. According to the safety buffer for guide rails in claim 1, characterized in that, said rack (8) has a single tooth on one side of the drawer along the direction of pulling out the drawer, and the single tooth is arranged to be non-continuous and at a certain interval with other tooth.
